(19) United States
(12) Patent Application Publication
(10) Pub. No.: US 2011/0244220 A1
(43) Pub. Date: Oct. 6, 2011

(54) Metals parts containing a protective coating

(75) Inventors: Placido Garcia-Juan, Hannover (DE); Ulrich Seseke-Koyro, Isernhagen (DE); Dagmar Bonhage, Wennigsen (DE)

(73) Assignee: SOLVAY FLUOR GMBH, Hannover (DE)

(21) Appl. No.: 13/133,562

(22) PCT Filed: Dec. 14, 2009
(86) PCT No.: PCT/EP09/67043

§ 371 Date: Jun. 8, 2011

(30) Foreign Application Priority Data
Dec. 16, 2008 (EP) 08171855.3

(51) Int. Cl. B32B 15/04; C09D 1/00; B32B 5/16; C01G 23/04

(52) U.S. Cl. 428/328; 428/472; 106/287.19; 428/402; 423/472

(57) ABSTRACT

Metal parts, especially parts made from aluminium, aluminium alloys, steel and stainless steel, are described which comprise a coating containing TiOF₂ or titanyl hydroxyfluorides. The coating protects against corrosion. Titanium oxyfluoride and titanyl hydroxyfluorides in the form of a gel are also disclosed, as well as particulate Ti_{0.85}O_{0.55}(OH)_{1.1}F_{1.2} having a specific particle size.

The invention relates to parts made from metals, especially aluminium, iron, steel and stainless steel, containing a protective coating comprising titanium oxyfluoride or titanyl hydroxyfluoride; the invention further relates to titanyl oxyfluoride with the formula TiOF₂ and to titanylhydroxyfluorides, especially the compound with the formula Ti_{0.85}O_{0.55}(OH)_{1.1}F_{1.2}, in the form of a gel or micronized particles of that specific compound.

The application of conversion coatings is a useful method to improve metal surfaces in view of corrosion. For example, it is well known to treat parts made of metal, for example, made of aluminium or steel, with chromium phosphate in the presence of fluoride, zinc phosphate in the presence of fluoride or iron phosphate. Coatings are formed which protect the aluminium against corrosion. Depending on the compound used, aluminium fluoride, aluminium phosphate, chromium phosphate, chromium chromate, chromyl fluoride or aluminium oxide coatings are formed. Due to the toxicity of chromium compounds, alternatives were searched, and hexafluorozirconium acid or hexafluorotitanium acid were applied as treatment agents. This is described in P. Gillis de Lange, Powder Coatings, Chemistry and Technology, Wiley & Sons, 2^{nd} edition (1991), pages 332 to 339.

Object of the present invention is to provide metal parts containing a protective coating and an advantageous process for applying a protective conversion coating to metals without using chromium compounds. Another object of the present invention is to provide titanium compounds suitable as active ingredient in protective coatings. Another object of the present invention is to provide a technically feasible process to produce a specific titanyl hydroxyfluoride, namely Ti_{0.85}O_{0.55}(OH)_{1.1}F_{1.2}; in this formula, the indices are variable in a range of ±0.03. Another object of the present invention is to provide titanium oxyfluoride or titanyl hydroxyfluorides in the form of a gel.

These and other objects are achieved by the invention as set out in the claims.

According to the present invention, a metal part is provided wherein at least a part of it contains a coating comprising a titanium oxyfluoride compound or a titanyl hydroxyfluoride compound or a mixture thereof.

The terms “titanium oxyfluoride” or “titanium oxyfluoride compound” denotes compounds which consist of titanium, oxygen, and fluoride. The term “titanyl hydroxyfluoride” denotes compounds consisting of titanium, oxygen, fluorine and hydrogen; they have OH groups.

According to one embodiment, the coating consists of the titanium oxyfluoride compound or the titanyl hydroxyfluoride compound or a mixture thereof.

According to one preferred embodiment, the titanium oxyfluoride compound or titanyl hydroxyfluoride compound is contained in micronized form, especially in a particle size equal to or smaller than 20 μm. Preferably, the secondary particle size is essentially equal to or lower than 10 μm. Especially preferably, it is essentially equal to or lower than 7 μm. Generally, the secondary particle size is essentially equal to or greater than 700 nm. Of course, the product may contain insignificant amounts of oversized or undersized secondary particles. The term “essentially” denotes in view of the secondary particle size that equal to or less than 10% by weight of the product is constituted by particles which are smaller than the lower size limit given above, and that equal to or less than 10% by weight of the product is constituted by particles which are greater than the upper size limit given above.

The primary particle size preferably lies in the nano range. This means that the primary particle size of the particles in the product are preferably equal to or smaller than 500 nanometers, especially preferably equal to or smaller than 400 nm.

The particulate product adheres very well to the metal surface.

Secondary particles with such a small size can, for example, be obtained by extensive ball-milling. A specific method to obtain micronized particles of a specific titanyl hydroxyfluoride compound, Ti_{0.85}O_{0.55}(OH)_{1.1}F_{1.2}, is described below.

According to another embodiment, the titanium compound is contained in the coating in the form of a gel. A method for the manufacture of titanium oxyfluoride compounds in the form of a gel is described later.

In one embodiment, titanium oxyfluoride, TiOF₂, is applied. TiOF₂ can be prepared by partial hydrolysis of TiF₄ or titanium alkoxides.

In another embodiment, titanyl hydroxyfluorides atoms are contained. The hydrogen in these compounds is contained in a hydroxyl group. Generally, these compounds are titanium hydroxy oxyfluorides and can be expressed by the formula TiₐO_{b}(OH)_{c}F_{d}. The compounds can be non-stoichiometric, and thus, a, b, c and d are not necessarily integers; a is 0.8 to 1.2; b is 0.5 to 1.7; c is 0.2 to 1.7; and d is 0.2 to 1.8. Generally, titanyl hydroxyfluorides can be manufactured from titanyl chloride (TiOCl₂) in the form of a solution in hydrochloric acid to which hydrofluoric acid is added. An alternative method which delivers the compounds in gel form concerns the hydrolysis of titanium alcoholates with aqueous HF. Both processes will be described in detail below.

Any titanyl hydroxyfluoride can be contained, for example, the ReO₃-type compound of formula Ti_{0.9}O_{0.6}(OH)_{1.6}F_{1.8}, or Anatas-type Ti_{0.9}O_{1.6}(OH)_{0.2}F_{0.2} as they are described by Nicolas Penin et al. in Mat. Res. Soc. Symp. Proc. Vol. 891, 0891-EE07-04.1. The application of Ti_{0.85}O_{0.55}(OH)_{1.1}F_{1.2} which crystallizes as HTB (hexagonal tungsten bronze type) and is also described by Penin et. al., and of TiF₂ and Ti_{0.85}O_{0.55}(OH)_{1.1}F_{1.2} in gel form is preferred. A technically feasible process for the preparation of these compounds will be described in detail later.

The metal part which is at least partially coated can principally be any metal or metal alloy. Preferably, it is made of aluminium, aluminium alloys, steel or stainless steel.

The metal part principally can have any form. It can be, for example, part of any good containing metal parts. For example, it can be part of heat exchangers, or construction parts made of aluminium or aluminium alloys such as aluminium-magnesium alloy. If desired, it can be subjected to a cleaning step, for example, with a base, an acid, a degreasing agent or a water-removing agent before being coated with the titanium oxy fluoride or titanium oxy hydroxyfluoride particles. If desired, the surface can be polished or abraded, sanded, grinded or even treated by a chemical mechanical polishing method.

In the following, it is described how metal parts containing the titanium oxyfluoride compound or a titanyl hydroxyfluoride compound or a mixture thereof can be manufactured.

The process for manufacture of metal parts with improved protection against corrosion comprising a step of coating the metal parts with a coating containing a titanium compound selected from the group consisting of titanyl oxyfluoride and titanyl hydroxyfluorides of general formula TiₐO_{b}(OH)_{c}F_{d} wherein a is 0.8 to 1.2; b is 0.5 to 1.7; c is 0.2 to 1.7; and d is 0.2 to 1.8. The process preferably applies a titanium compound selected from the group consisting of titanyl oxyfluoride and titanyl hydroxyfluorides of general formula TiₐO_{b}(OH)_{c}F_{d} wherein a is 0.8 to 1.2; b is 0.5 to 1.7; c is 0.2 to 1.7; and d is 0.2 to 1.8. Preferably, the metal part is made from aluminium, aluminium steel or stainless steel. The titanium compound is applied in the coating step in the form of a gel or in the form of micronized particles.

It is preferred to apply in the process a titanium compound selected from the group consisting of Ti_{0.85}O_{0.55}(OH)_{1.1}F_{1.2} which is crystallized in the HTB structure (hexagonal tungsten bronze) wherein the indices are variable in a range of ±0.03; TiOF₂; Ti_{0.9}O_{0.6}(OH)_{1.6}F_{1.8}, and Ti_{0.9}O_{1.6}(OH)_{0.2}F_{0.2}. More preferably, titanium compound selected from the group consisting of Ti_{0.85}O_{0.55}(OH)_{1.1}F_{1.2} which is crystallized in the HTB structure (hexagonal tungsten bronze) wherein the indices are variable in a range of ±0.03; Ti_{0.9}O_{0.6}(OH)_{1.6}F_{1.8}, and Ti_{0.9}O_{1.6}(OH)_{0.2}F_{0.2} is applied.

Ti_{0.85}O_{0.55}(OH)_{1.1}F_{1.2} constituted from particles with a primary particle size essentially in the range of 100 to 700 nm and a secondary particle size essentially in the range of 1 to 5 μm, or in the form of a gel is especially preferred in the manufacturing process.

According to one embodiment, the titanium oxyfluoride compound or a titanyl hydroxyfluoride compound or a mixture thereof are applied as a dry powder. For example, the powder can be applied electrostatically by means of a spray gun. If desired, the coated parts can be heated, e.g. to a temperature of equal to or less than 110° C. to improve the adhesion of the coating.

According to another embodiment, the titanium oxyfluoride compound or a titanyl hydroxyfluoride compound or a mixture thereof is applied in the form of a wet composition. The wet composition contains the titanium oxyfluoride compound, a titanyl hydroxyfluoride compound or a mixture thereof and a solvent, preferably an organic solvent, for example, an ether, a ketone, an alcohol, a nitrile, a formamide or other organic protic or aprotic solvents with low acidity, for example alcohols. Diethyl ether, diisopropyl ether, di-n-propyl ether, acetone, methyl butyl ketone, methanol, ethanol, n-propanol, i-propanol, n-butanol, i-butanol, t-butanol, acetonitrile, N,N-dimethylformamide, and N,N-diethylformamide are especially suitable. Dibasic or tribasic alcohols, e.g. ethylene glycol or glycerine, or etheralcohols for example, methoxyethanol, ethoxyethanol, butoxyethanol, diethylene glycol, or dimethyldiethylene glycol, are also suitable. If desired, the titanium oxyfluoride compound or a titanyl hydroxyfluoride compound or a mixture thereof can be contained in the solvent as a gel. After the composition was applied to the metal part, e.g. by spraying, painting, or by dipping the part into the composition, the coated part is dried to remove the solvent. A coating of the titanium oxyfluoride compound or a titanyl hydroxyfluoride compound or a mixture thereof is formed.

Depending on the concentration of the titanium compound, the viscosity is low so that the resultant gel is pourable and can be painted, sprayed or printed onto the metal surface, or the metal parts can be dipped into the gel, The viscosity may be higher. The gel can even be considered as solid because it cannot be poured anymore. Often, a content of 10 to 15% by weight of the titanium compound is sufficient to render the gel solid. If desired, solvent can be added, and the viscosity reduced thereby; then, the resulting gel solution can be applied as described above. If desired, the titanium compound can be applied together with a binder, for example, with a binder selected from the group consisting of polyacrylates, polyvinyl alcohols, polyurethanes and butyl rubber.

It is possible to apply the conversion coating after brazing of, for example, aluminium parts. Brazing of aluminium parts is an important field of technology. For example, heat exchangers are produced by assembling aluminium parts to be joined, e.g. fins, lines for the heat-transporting agent etc., and by brazing the assembled parts. As is well known to the expert in this field, solder (e.g. aluminium silicon alloys) or solder precursors (e.g. silicon, copper or germanium) are applied to achieve a reliable joinder. Fluxing agents are applied in the brazing step to remove aluminium oxide (which otherwise would prevent the formation of reliable joinders) from the surface of the aluminium parts to be joined. A well-known non-corrosive flux is potassium fluoroaluminate which is available under the trade name NOCOLOK® from Solvay Fluor GmbH.

According to one embodiment, titanium oxyfluoride of formula TiOF₂ is applied. It is preferably applied in the form of micronized particles. The term “micronized particles” means also here that the secondary particle size of the product is essentially equal to or lower than 20 μm; the term “essentially” means here that at most 10% by weight of the particles have a size of more than 20 μm. Preferred particle sizes correspond to those given above for the micronized particles.

Alternatively, in another preferred embodiment, the titanium oxyfluoride is applied in the form of a gel. It can be applied as a lyogel or organic gel; this means that It comprises the inorganic compound finely dispersed in an organic carrier. Alternatively, it may be used in the form of dry particles as xerogel. This means that it was produced by removing an organic solvent without changing the gel structure.

According to another embodiment, titanyl hydroxyfluoride is applied in the process of the present invention. Any titanyl hydroxyfluoride of formula TiₐO_{b}(OH)_{c}F_{d} is suitable, for example, ReO₃-type compound of formula Ti_{0.9}O_{0.6}(OH)_{1.6}F_{1.8}, or Anatas-type Ti_{0.9}O_{1.6}(OH)_{0.2}F_{0.2} as mentioned above. The application of Ti_{0.85}O_{0.55}(OH)_{1.1}F_{1.2} which crystallizes as HTB (hexagonal tungsten bronze type) is preferred. It was found that this compound forms stable suspensions, especially in alcohols. Accordingly, handling of this compound during its application is simplified. It is further preferred in this embodiment to apply Ti_{0.85}O_{0.55}(OH)_{1.1}F_{1.2} in gel form.

It is especially preferred to apply the titanyl hydroxyfluoride in the form of micronized particles or in the form of a gel.

Another aspect of the present invention concerns TiOF₂ and titanyl hydroxyfluoride compounds of formula TiₐO_{b}(OH)_{c}F_{d}. The compounds can be non-stoichiometric, and thus, a, b, c and d are not necessarily integers; a is 0.8 to 1.2; b is 0.5 to 1.7; c is 0.2 to 1.7; and d is 0.2 to 1.8. in the form of a gel, preferably a lyogel in an organic solvent, or in the form of a xerogel. The preferred titanyl hydroxyfluoride compound has the formula Ti_{0.85}O_{0.55}(OH)_{1.1}F_{1.2} wherein the indices are variable in a range of ±0.03.

TiOF₂ in the form of a gel and titanyl hydroxyfluoride compounds of formula TiₐO_{b}(OH)_{c}F_{d} wherein a is 0.8 to 1.2; b is 0.5 to 1.7; c is 0.2 to 1.7; and d is 0.2 to 1.8; especially Ti_{0.85}O_{0.55}(OH)_{1.1}F_{1.2} in the form of a gel can be prepared from titanium tetraalkoxides and HF in a solvent. For example, titanium compounds with methoxy, ethoxy, n-propoxy or i-propoxy groups can be used as starting material. The ratio of HF to titanium alkoxide preferably is equal to or greater than 1:1. Preferably, it is equal to or lower than 3:1. It was observed that T_{0.85}O_{0.55}(OH)_{1.1}F_{1.2} is formed if the molar ratio of HF to alkoxide is up to 1.6:1. If the ratio is higher, especially if it is 2:1 or higher, predominantly or even only, TiOF₂ is formed.

Protic or aprotic polar organic solvents with a low acidity, for example, alcohols, or aprotic organic solvents are very suitable, for example, ethers or ketones. Methanol, ethanol, i-propanol, n-propanol and methyl ethyl ketone are very suitable. The HF is preferably introduced in the form of an aqueous solution; this solution preferably contains 20 to 70% by weight of HF. The hydrolysis reaction is preferably performed at a temperature which is equal to or higher than 30° C.; the reaction temperature is preferably equal to or lower than the boiling point of the solvent. Especially preferably, it is equal to or lower than 100° C. To finalize the reaction, it may take up to 2 hours or even more. The formed gel is dried, or the reaction mixture containing the gel is applied in the coating process of the present invention. Optionally, the reaction mixture can be diluted or concentrated. If the solvent and any evaporizable constituents are removed, a xerogel is obtained.

In view of the application as conversion coating, it is preferred to apply directly the gel solution obtained during preparation. It should not contain HF; otherwise, HF must be removed prior to the application because it may be corrosive. It can for example be removed by distillation (its boiling point is 20° C.). Xerogels can be applied in dry form, or they can be resuspended in, for example, one of the solvents mentioned above or a mixture thereof. If desired, the xerogel can be ballmilled before to provide a finely divided powder.

The present invention also provides titanyl hydroxyfluoride, crystallized in the HTB form, of formula Ti_{0.85}O_{0.55}(OH)_{1.1}F_{1.2} wherein the indices are variable in a range of ±0.03, with a primary particle size essentially in the range of 100 to 700 nm and a secondary particle size essentially in the range of 1 to 5 μm.

Preferred is a titanyl hydroxyfluoride of claim 18 with a primary particle size essentially in the range of 100 to 300 nm and a secondary particle size essentially in the range of 1 to 2 μm.

Another aspect of the present invention concerns a technically feasible process for the preparation of Ti_{0.85}O_{0.55}(OH)_{1.1}F_{1.2}.

The process for the preparation of Ti_{0.85}O_{0.55}(OH)_{1.1}F_{1.2} includes a step wherein titanyl chloride (TiOCl₂) in the form of a solution in hydrochloric acid is provided to which hydrofluoric acid is added with the proviso that the molar ratio of HF to titanylchloride is equal or lower than 2. The compound crystallizes in the HTB structure (hexagonal tungsten bronze).

In a preferred embodiment, the ratio of HF to titanyl chloride is equal to or lower than 1.6. The ratio of HF to titanyl chloride is preferably equal to or higher than 1.3; a very preferred range is 1.4 to 1.5:1.

The pressure during the reaction is preferably equal to or than lower than 10 bar (abs.), more preferably equal to or lower than 3 bar (abs.), very preferably equal to or lower than 2 bars (abs.), especially preferably equal to or lower than 1.5 bar (abs.). The pressure may even be lower than 1 bar (abs.), for example, 0.8 bar (abs.). Preferably, the pressure is equal to or greater than 0.9 bar (abs.). In a preferred embodiment, the reaction is performed at ambient pressure. The term “ambient pressure” preferably denotes a pressure between 0.9 and 1.1 bar (abs.) and often is approximately 1 bar (abs.).

The concentration of titanium in the form of titanyl chloride in the hydrochloric acid is preferably higher than 5% by weight. It is preferably equal to or lower than 25% by weight. Very preferably, it is in the range of 10 to 20% by weight. The concentration of HCl in the hydrochloric acid is preferably equal to or higher than 30% by weight. Preferably, it is equal to or lower than 50% by weight. More preferably, it is in the range of 35 to 45% by weight, especially preferably 38 to 42% by weight. HF is preferably added in the form of a solution in water. Often, the lower concentration limit of HF is 20% by weight, preferably 30% by weight. The upper limit is often 70% by weight, preferably 60% by weight.

A slow addition of hydrofluoric acid is preferred. It can be added to the titanyl chloride with a speed of, e.g., 0.5 to 10 mol HF per mol titanyl chloride per hour. Preferably, the hydrofluoric acid is added to the solution of the titanyl chloride with a speed of 1 to 7 mol HF per mol of titanyl chloride and hour. It is advantageous to provide intensive mixing. This is described below. It also can be advantageous to enter the HF solution in the form of droplets.

During addition of HF, a temperature rise is observed. It is assumed that this is caused by heat released by dilution of HF. After addition of the hydrofluoric acid is completed, the reaction mixture is preferably subjected to a post-reaction phase. The post reaction phase if applied, preferably lasts at least 30 minutes. Very preferably, it lasts at least 2 hours. While the post reaction phase can be applied for 1 day or longer, preferably it is equal to or less than 10 hours. A very preferred range is 2 to 8 hours, and still more preferably 2 to 6 hours. During this post-reaction phase, the temperature of the reaction mixture is preferably kept in a range of 70 to 100° C., especially preferably in the range of 80 to 90° C.

It is preferred to apply, and accordingly, to produce a product with micronized particles. The term “micronized particles” means that the secondary particle size of the product is essentially equal to or lower than 20 μm. Preferably, the secondary particle size is essentially equal to or lower than 10 μm. Especially preferably, it is essentially equal to or lower than 7 μm. Generally, the secondary particle size is essentially equal to or greater than 700 nm. Of course, the product may contain insignificant amounts of oversized or undersized secondary particles. The term “essentially” denotes in view of the secondary particle size that equal to or less than 10% by weight of the product is constituted by particles which are smaller than the lower size limit given above, and that equal to or less than 10% by weight of the product is constituted by particles which are greater than the upper size limit given above.

The primary particle size preferably lies in the nano range. This means that the primary particle size of the particles in the product are preferably equal to or smaller than 500 nanometers, especially preferably equal to or smaller than 400 nm. To obtain particles with nanoscale primary particle size, e.g., with primary particles in the range of 100 to 300 nm, and secondary particles in the preferred lower micronized range, e.g. in the range of 1 to 2 μm, forces are applied during precipitation to comminute the particles or reduce agglomeration. The reaction mixture is preferably agitated, for example, with a stirrer; it is especially preferably heavily agitated, e.g. by applying a stirrer operated with high speed, for example, more than 100 rpm, preferably more than 300 rpm, especially more than 500 rpm, still more preferably more than 1000 rpm. Often, a stirrer rotating with more than 2000 rpm is advantageous. Upper limit of the rotational speed is determined by the stirrer. Preferably, 10.000 rpm is usually the upper limit. Often, stirring with 1000 rpm to 6000 rpm is advantageous. This agitation can be applied preferably during the addition of the HF solution, during the post-reaction phase or both. It is assumed that the reaction may be performed in a mixer operating according to the rotor stator principle with high speed (several thousands of rounds per minute) of the rotor. The reaction and the post-reaction phase can also be performed in a dissolver. A dissolver usually comprises a disperser disk which often is toothed and rotates with high speed thereby accelerating the mixture radially. When the reaction itself is, for example, performed in a dissolver, particles are obtained with desired small primary particle size and desired small secondary particle size.

The product precipitates during the reaction. The water content of the reaction mixture is then removed. It is preferred to remove part of the water e.g. by filtration, decantation, centrifugation and/or heating, for example, by drying it in an oven. Residual water is then preferably removed by heating, e.g. in an oven, optionally under the application of a vacuum. The product preferably is oven dried, especially preferably at a temperature in the range of 70 to 110° C., preferably 80 to 100° C.

REM images show that in this manner, particles can be obtained essentially with a primary particle size in the range between 100 nm and 300 nm; some particles even have a size less than 100 nm. The secondary particle size lies essentially in the range of 1 to 2 μm. Ti_{0.85}O_{0.55}(OH)_{1.1}F_{1.2} is obtained in nearly quantitative yield, typically in the form of particles with a primary particle size essentially between 100 nm and 700 nm and agglomerates (secondary particles) with a size essentially in the range of 1 to 5 μm. The secondary particle size can even be lower depending on the power of comminuting forces or agglomeration-preventing forces. Thus, by means of high-speed stirring as described above, a product is obtained in the form of particles with a primary particle size essentially between 100 nm and 300 nm and agglomerates (secondary particles) with a size essentially in the range of 1 to 2 μm. The term “essentially” means her that equal to or more than 80% by weight, preferably equal to or more than 90% by weight of the product is constituted by particles in the given size range.

The precipitate can be dried without further treatment. Preferably, it is rinsed with distilled water after the post reaction phase. It can also be re-suspended in water or distilled water and then be dried.

The dried product can be comminuted in a milling operation, e.g. a ball mill. This serves to destroy undesired agglomerates.

If desired, during the reaction, in the post-reaction phase or during re-dispersion, a dispersant can be added.

The inventive process for the preparation of Ti_{0.85}O_{0.55}(OH)_{1.1}F_{1.2} wherein the indices are variable in a range of ±0.03 can be performed in an industrial scale in a very simple manner. In a preferred embodiment, no pressure is applied, making the process very safe; additional advantage is that no pressure-resistant apparatus is needed in that embodiment. No microwave treatment is necessary.

Ti_{0.85}O_{0.55}(OH)_{1.1}F_{1.2} wherein the indices are variable in a range of ±0.03 with a primary particle size essentially in the range of 100 to 300 nm and a secondary particle size essentially in the range of 1 to 2 μm is novel and is also an aspect of the present invention. Here, the term “essentially” means that equal to or less than 10% by weight of the particles has a primary particle size or secondary particle size, respectively, which is equal to or lower than the lower range given. The term “essentially” means here that equal to or less than 10% by weight of the particles has a primary particle size or secondary particle size, respectively, which is equal to or greater than the upper range given.

The product can be applied together with the flux in dry form, as paste or as suspension. It was found that it forms very stable suspensions in organic solvents, especially in alcohols, e.g. in isopropanol. Suspensions comprising Ti_{0.85}O_{0.55}(OH)_{1.1}F_{1.2} are another embodiment of the present invention.

The compounds prepared according to the process of the present invention can be used, as described, for applying coatings on metals, especially on aluminium, to protect them against corrosion.

The following examples shall describe the invention further without being intended to limit it.

### EXAMPLES

### A) Preparation of Titanyl Hydroxyfluorides

The reaction can be described as follows:

TiOCl₂+yHF+xH₂O→TiₐO_{b}(OH)_{c}F_{d}+2HCl

% always denotes % by weight.

### Example 1

### Preparation of Ti_{0.85}O_{0.55}(OH)_{1.1}F_{1.2}

204 ml of a solution of TiOCl₂ (15% Ti) in HCl (38-42%) were placed in a water-jacked polypropylene beaker. The content of the beaker was agitated by means of a magnetic stirrer. The vessel was externally heated and the temperature in the solution was monitored with a Pt-100 thermometer. The equivalent amount of titanium in the solution was 1 mol. 56 g of a 50% HF solution (1.4 mol HF) were slowly added drop wise. At this stage a temperature increase to 49° C. was recorded. The temperature was risen to 85° C. and agitated for 5 hours. After cooling down the precipitated mass was oven-dried at 90° C.

By XRD measurements a crystalline phase of the compound Ti_{0.85}O_{0.55}(OH)_{1.1}F_{1.2} was identified. The elemental analysis was 43.7% Ti, 22.3% F, 1.00% Cl; the reminder to 100% by weight is 0 and H. The particles presented diameters between 1-5 μm.

### Example 2

### Preparation of Ti_{0.85}O_{0.55}(OH)_{1.1}F_{1.2}, Temperature Rise to 47° C. and Rinsing of the Precipitate with Water

204 ml of a solution of TiOCl₂ (15% Ti) in HCl (38-42%) were placed in a water jacked polypropylene beaker. The content of the beaker was agitated by means of a magnetic stirrer. The vessel was heated by an external heater and the temperature in the solution was monitored with a Pt-100 thermometer. The equivalent amount of titanium in the solution was 1 mol. 56 g of a 50% HF solution (1.4 mol HF) were slowly added drop wise to the latter solution. At this stage a temperature increase to 47° C. was recorded. The temperature, in a post-reaction phase, was increased to 85° C. and the mixture agitated for 5 hours. After cooling down the precipitated mass was rinsed with water and separated by centrifugation and decantation. The latter step was repeated three times. The obtained mass was then oven-dried at 90° C.

By XRD measurements a crystalline phase of the compound Ti_{0.85}O_{0.55}(OH)_{1.1}F_{1.2} was identified. The elemental analysis was 45.1% Ti, 25.3% F, 0.2% Cl. The aspect, as in example 1, was evaluated by electron microscopy (SEM). The agglomerates presented diameters between 1-5 μm, with primary particles sizes between 300-700 nm.

### Example 3

### Preparation of Ti_{0.85}O_{0.55}(OH)_{1.1}F_{1.2}, Stirring with 5000 rpm in the Post-Reaction Phase

408 ml of a solution of TiOCl₂ (15% Ti) in HCl (38-42%) were placed in a water jacked polypropylene beaker. The content of the beaker was agitated by means of a high speed mixer. The vessel was heated up by an external heater and the temperature in the solution was monitored with a Pt-100 thermometer. The equivalent amount of titanium in the solution is 2 mol. To this solution 120 g of a 50% HF solution (3 mol HF) were slowly added dropwise while stirring the mixture at a rate of 500 rpm. At this stage a temperature increase to 44° C. was recorded. In a post reaction phase, the temperature was increased to 85° C. and the mixture was agitated at 5000 rpm for 6 hours. After cooling down the precipitated mass was re-suspended in water, agitated and separated by centrifugation and decantation. The obtained solid was oven dried at 90° C.

By XRD measurements a crystalline phase of the compound Ti_{0.85}O_{0.55}(OH)_{1.1}F_{1.2} was identified. The elemental analysis was 43.3% Ti, 24.6% F, 0.37% Cl. The aspect was evaluated by electron microscopy (SEM). The agglomerates have a spherical form with diameters between 1-2 μm. The primer particles have diameters of 100-300 nm.

### B) Preparation of Titanium Oxyfluoride and Titanyl Hydroxyfluoride in Gel Form

The reactions can be described as follows:

Ti(OR)₄+2HF+yH₂O→Ti(O)F₂+2ROH

Ti(OR)₄+xHF+yH₂O→Tiₐ(O)_{b}(OH)_{c}F_{d}+2ROH

### Example 4

### Preparation of TiOF₂ Gel

Starting Material:

| | | |
|---|---|---|
| Aqueous HF, concentration 50% by weight | 14.1 | g |
| Ti(O-i-propyl)₄ | 52.5 | g |
| Isopropanol (“IPA”) | 300 | ml |

Molar ratio of Ti:F = 1:2

The titanium isopropanolate was weighed into a three-neck round flask, equipped with stirrer and reflux cooler, and mixed with 200 ml of isopropanol. At room temperature, under sweeping the flask with nitrogen, a mixture of 14.1 g of the aqueous HF and 100 ml IPA was added dropwise while the reaction mixture was stirred. After termination of adding the mixture, the content of the flask was heated to 70° C. Any formed vapors were condensed in the cooler and are returned to the flask. After 3.5 hours, a slight cloudiness could be observed. A lyogel was formed.

A TiOF₂ xerogel can be isolated by removing the isopropanol and any other volatile constituents.

The lyogel can be painted directly on metal surfaces with a subsequent drying step to provide a coated metal part (see example 11).

Alternatively, the xerogel can be suspended in a solvent, for example, isopropanol or methyl ethyl ketone, and painted onto the metal surface. Once again, a subsequent drying step provides metal parts with a protective coating.

### Example 5

### Preparation of Ti_{0.85}O_{0.55}(OH)_{1.1}F_{1.2}

Starting Material:

| | | |
|---|---|---|
| Aqueous HF, concentration 57% by weight | 9.9 | g |
| Ti(O-i-propyl)₄ | 50 | g |
| Methyl ethyl ketone (“MEK”) | 300 | ml |

Molar ratio of Ti:F = 1:1.6

The titanium isopropanolate was mixed in the three neck flask of example 4 with 200 ml MEK. At room temperature, a mixture of 9.9 g aqueous HF and 100 ml MEK was added dropwise. After termination of the addition of the HF solution, the reaction mixture was stirred for 3.5 h at 70° C.

After cooling to ambient temperature, a slight flocculation could be observed.

The resultant Ti_{0.85}O_{0.55}(OH)_{1.1}F_{1.2} lyogel can be isolated by removal of the solvent.

### Example 6

### Preparation of Ti_{0.85}O_{0.55}(OH)_{1.1}F_{1.2}

Starting Material:

| | | |
|---|---|---|
| Aqueous HF, concentration 42% by weight | 7.2 | g |
| Ti(O-i-propyl)₄ | 30 | g |
| Methyl ethyl ketone (“MEK”) | 100 | ml |

Molar ratio of Ti:F = 1:1.6

The titanium isopropanolate was mixed in the three neck flask of example 4 with 80 ml of MEK. At room temperature, a mixture of 7.2 g aqueous HF and 20 ml MEK was added drop wise. After termination of the addition of the HF solution, the reaction mixture was stirred for 3.5 h at 70° C.

After cooling to ambient temperature, a slight flocculation could be observed. The gel solution is ready for use.

The resultant Ti_{0.85}O_{0.55}(OH)_{1.1}F_{1.2} lyogel can be isolated in the form of a xerogel by removal of the solvent.

### Example 7

### Preparation of Ti_{0.85}O_{0.55}(OH)_{1.1}F_{1.2}

Starting Material:

| | | |
|---|---|---|
| Aqueous HF, concentration 40% by weight | 2 | g |
| Ti(O-ethyl)₄ | 10 | g |
| Methyl ethyl ketone (“MEK”) | 30 | g (20 g + 10 g) |
| Nuosperse ® 2008 | 0.4 | g (0.3 g + 0.1 g) |

Molar ratio of Ti:F = 1:1

The titanium ethanolate was mixed in a beaker with 20 g MEK and 0.3 g Nuosperse® 2008, a pigment surfactant (modified oleyl alcohol) available from Elementis Specialties Netherlands B.V. At room temperature, a mixture of 2 g aqueous HF, 10 g MEK and 0.1 g Nuosperse® 2008 was added dropwise. Shortly before termination of the addition of the HF solution, the reaction mixture turned white and solidified. The resultant gel was dried overnight at 100° C.

### Example 8

### Preparation of Ti_{0.85}O_{0.55}(OH)_{1.1}F_{1.2}

Starting Material:

| | | |
|---|---|---|
| Aqueous HF, concentration 57% by weight | 8 | g |
| Ti(O-n-butyl)₄ | 40 | g |
| Methyl ethyl ketone (“MEK”) | 250 | ml |

Molar ratio of Ti:F = 1:1.6

The titanium isopropanolate was mixed in the three neck flask of example 4 with 200 ml of MEK. At room temperature, a mixture of 8 g aqueous HF and 50 ml MEK was added dropwise. After termination of the addition of the HF solution, the reaction mixture was stirred for 2 h at 70° C. A transparent gel formed.

The gel can be directly used to provide coated parts, or the solvent can be removed by drying, and the xerogel can be resuspended before its application.

### Example 9

### Manufacture of Aluminium Parts with a Coating Containing Comprising Ti_{0.85}O_{0.55}(OH)_{1.1}F_{1.2}

Ti_{0.85}O_{0.55}(OH)_{1.1}F_{1.2} obtained in example 3, is dispersed in methyl ethyl ketone. The dispersion is painted onto the surface of an aluminium coupon. The coupon is then dried in an oven at 70° C. After cooling, a coupon is obtained which is coated with a coating of Ti_{0.85}O_{0.55}(OH)_{1.1}F_{1.2}.

### Example 10

### Manufacture of Aluminium Parts with a Coating Containing Comprising Ti_{0.85}O_{0.55}(OH)_{1.1}F_{1.2}

A part of the xerogel of example 8 is comminuted in a ball mill and then suspended in MEK and painted on the surface of an aluminium angle. The coupon is then transferred to an oven, and the solvent is removed. After cooling, an aluminium coupon coated with a coating containing comprising Ti_{0.85}O_{0.55}(OH)_{1.1}F_{1.2} is obtained.

### Example 11

### Manufacture of Aluminium Parts with a Coating Containing Comprising TiOF₂

A part of the solution of the TiOF₂ gel in isopropanol obtained in example 4 and painted on the surface of an aluminium angle. The coupon is then transferred to an oven, and the solvent is removed. After cooling, an aluminium coupon coated with a coating containing comprising TiOF₂ is obtained.

### Example 12

### Manufacture of Aluminium Parts with a Coating Containing Comprising Ti_{0.85}O_{0.55}(OH)_{1.1}F_{1.2}

A part of the gel product obtained in example 8 is directly used to be painted on the surface of an aluminium angle. The coupon is then transferred to an oven, and the MEK solvent is removed. After cooling, an aluminium coupon coated with a coating containing comprising Ti_{0.85}O_{0.55}(OH)_{1.1}F_{1.2} is obtained.

1. A metal part with improved protection against corrosion comprising a coating containing a titanium compound selected from the group consisting of titanyl oxyfluoride and titanyl hydroxyfluorides of general formula TiₐO_{b}(OH)_{c}F_{d} wherein a is 0.8 to 1.2; b is 0.5 to 1.7; c is 0.2 to 1.7; and d is 0.2 to 1.8.

2. The metal part of claim 1 wherein the titanium compound is selected from the group consisting of titanyl hydroxyfluorides of general formula TiₐO_{b}(OH)_{c}F_{d} wherein a is 0.8 to 1.2; b is 0.5 to 1.7; c is 0.2 to 1.7; and d is 0.2 to 1.8.

3. The metal part according to claim 1 wherein the metal part is made from aluminium, aluminium alloys, steel or stainless steel.

4. The metal part according to claim 1 wherein the titanium compound is contained in the coating in the form of a gel or in the form of micronized particles.

5. The metal part according to claim 1 wherein the titanium compound is selected from the group consisting of Ti_{0.85}O_{0.55}(OH)_{1.1}F_{1.2} which is crystallized in the hexagonal tungsten bronze (HTB) structure wherein the indices are variable in a range of ±0.03; Ti_{0.9}O_{0.6}(OH)_{1.6}F_{1.8}, and Ti_{0.9}O_{1.6}(OH)_{0.2}F_{0.2}.

6. The metal part of claim 5 wherein the titanium compound is Ti_{0.85}O_{0.55}(OH)_{1.1}F_{1.2}.

7. The metal part according to claim 6 wherein the Ti_{0.85}O_{0.55}(OH)_{1.1}F_{1.2} is present in the form of a gel or constituted from particles with a primary particle size essentially in the range of 100 to 700 nm and a secondary particle size essentially in the range of 1 to 5 μm.

8. Titanyl hydroxyfluoride, crystallized in the hexagonal tungsten bronze (HTB) form, of formula Ti_{0.85}O_{0.55}(OH)_{1.1}F_{1.2} wherein the indices are variable in a range of ±0.03, with a primary particle size essentially in the range of 100 to 700 nm and a secondary particle size essentially in the range of 1 to 5 μm.

9. The titanyl hydroxyfluoride of claim 8 with a primary particle size essentially in the range of 100 to 300 nm and a secondary particle size essentially in the range of 1 to 2 μm.

10. A suspension of Ti_{0.85}O_{0.55}(OH)_{1.1}F_{1.2} in a mono- or dibasic alcohol, in a ketone, or in an ether.

11. A titanium compound in the form of a gel, selected from the group consisting of TiOF₂ and TiₐO_{b}(OH)_{c}F_{d} wherein a is 0.8 to 1.2; b is 0.5 to 1.7; c is 0.2 to 1.7; and d is 0.2 to 1.8.

12. The titanium compound of claim 11 being TiOF₂ or Ti_{0.85}O_{0.55}(OH)_{1.1}F_{1.2}.

13. A process for the preparation of Ti_{0.85}O_{0.55}(OH)_{1.1}F_{1.2} which crystallizes in the hexagonal tungsten bronze (HTB) structure wherein the indices are variable in a range of ±0.03, comprising providing a solution of titanyl chloride in hydrochloric acid, and adding hydrofluoric acid to the solution with the proviso that the molar ratio of HF to titanylchloride is equal or lower than 2.

14. A process for the preparation of a titanium compound in the form of a gel, selected from the group consisting of TiOF₂ and TiₐO_{b}(OH)_{c}F_{d} wherein a is 0.8 to 1.2; b is 0.5 to 1.7; c is 0.2 to 1.7; and d is 0.2 to 1.8, said process comprising reacting a titanium tetraalkoxide with aqueous HF in an organic solvent.

15. The process of claim 14 wherein the organic solvent is selected from the group consisting of ethers, ketones, alcohols, nitriles, and formamides.

16. The process of claim 15 wherein the titanium tetraalkoxide is selected from the group consisting of titanium tetraethanolates, titanium tetrakis-isopropanolates, titanium tetrakis-n-propanolates, and titanium tetrakis-n-butanolates.

17. The suspension of claim 10, being in a C1 to C4 monobasic alcohol.
